(19) United States
(12) Patent Application Publication
(10) Pub. No.: US 2018/0224657 A1
(43) Pub. Date: Aug. 9, 2018

(54) Integrated Wide Field of View Optical System for Image Based Navigation Applications in G-hardened Package

(71) Applicant: The Charles Stark Draper Laboratory, Inc., Cambridge, MA (US)

(72) Inventors: Matthew T. Jamula, Wilmington, MA (US); Matthew A. Sinclair, Stoneham, MA (US); Juha-Pekka J. Laine, Boston, MA (US); Paul A. Bohn, St. Petersburg, FL (US); Robin Dawson, Waltham, MA (US)

(21) Appl. No.: 15/888,306

(22) Filed: Feb. 5, 2018

Related U.S. Application Data
(60) Provisional application No. 62/455,014, filed on Feb. 6, 2017.

(51) Int. Cl. G02B 27/00; G02B 1/04; G02B 6/06; G02B 27/64; H04N 5/225

(52) U.S. Cl. CPC G02B 27/0081; G02B 1/041; H04N 5/2258; G02B 27/646; H04N 5/2252; G02B 6/06

(57) ABSTRACT

An optical device is described for a wide field of view optical system. A device housing has an optical opening into an enclosed interior volume. A multi-element lens is molded across the optical opening and defined by: a. a field of view representing a volume of space from which light is collected, b. a plurality of optical paths through the lens defining one or more focal planes within the interior volume, and c. a boresight axis perpendicular to each of the one or more focal planes. Optical sensors are arranged on the one or more focal planes and configured for sensing light collected through the lens from the field of view. The device forms a single environmentally hardened package configured to absorb impulse shocks without disturbing the boresight axis or the plurality of optical paths.

This application claims priority from U.S. Provisional Patent Application 62/455,014, filed Feb. 6, 2017, which is incorporated herein by reference in its entirety.

### TECHNICAL FIELD

The present invention relates to an improved optical device for a wide field of view optical system such as an optical navigation system.

### BACKGROUND ART

Wide field of view optical navigation systems have been described for applications such surveillance of near earth space; for example, celestial object sighting systems (COSS). The optical imaging devices in such systems may typically be based on a high-resolution monocentric multi-element ball lens in combination with one or more focal plane array optical sensor devices. Typically, there also may be corrective optics aligned behind the monocentric lens to isolate narrow portions of the system field of view. In addition or alternatively, fiber bundles may be mounted directly to the lens optics to transfer the sensed images back to a focal plane array.

Such systems work best when their environments are controlled to be relatively benign. But impulse shocks such as arise in many real life environments can give rise to boresight misalignments and image measurement errors. To minimize such problems, the physical mounting of the optical devices needs careful control to isolate the optical devices as best as possible from such impulse shocks. In addition, another related complexity arises as to securing optics and sensing elements to maintain desired camera/optical system properties while still remaining resilient enough to avoid over-stressing or mechanically breaking the system. Moreover, the manufacturing and integration process for such optical devices is complicated and costly. These optical devices are known to be sensitive to misalignments during integration, manufacturing, and assembly.

### SUMMARY

Embodiments of the present invention are directed to an optical device for an environmentally hardened wide field of view optical system. A device housing has an optical opening into an enclosed interior volume. A multi-element lens is molded across the optical opening and defined by: a. a field of view representing a volume of space from which light is collected, b. a plurality of optical paths through the lens defining one or more focal planes within the interior volume, and c. a boresight axis perpendicular to each of the one or more focal planes. Optical sensors are arranged on the one or more focal planes and configured for sensing light collected through the lens from the field of view. The device forms a single environmentally hardened package configured to absorb impulse shocks without disturbing the boresight axis or the plurality of optical paths.

In further specific embodiments, the lens may be formed of molded plastic material or molded glass material. The lens may specifically be a multi-element monocentric lens.

The optical sensors may be configured in one or more focal plane arrays such as one or more curved focal plane arrays. The optical sensors may include a single diamond turned optical fiber bundle, or multiple diamond turned optical fiber bundles. The optical sensors may be structurally integrated into the lens, or they may be structurally separate from the lens. In any of the embodiments, there may further be one or more optical corrective elements coupled to the optical sensors.

Embodiments of the present invention also include a wide field of view optical system having at least one optical device according to any of the foregoing.

### BRIEF DESCRIPTION OF THE DRAWINGS

FIG. 1 shows various structural elements in an optical device according to an embodiment of the present invention.

### DETAILED DESCRIPTION

Various embodiments of the present invention are directed to an improved optical device for wide field of view optical navigation systems that is environmentally hardened (gun-hardened) for image-based navigation. The hardened optical system survives impulse shocks such as gun shocks without disturbing the boresight axis or internal optical paths that could give rise to image-based measurement errors, thereby improving the accuracy of the image navigation algorithms. In addition, the underlying novel approach to fabricating the optical system provides ease of production at high volume throughputs while maintaining critical system parameters. The improved optical system is more easily integrated into higher level application systems by attaching the optical sensing elements to the passive optics without manufacturing misalignments that contribute to system error.

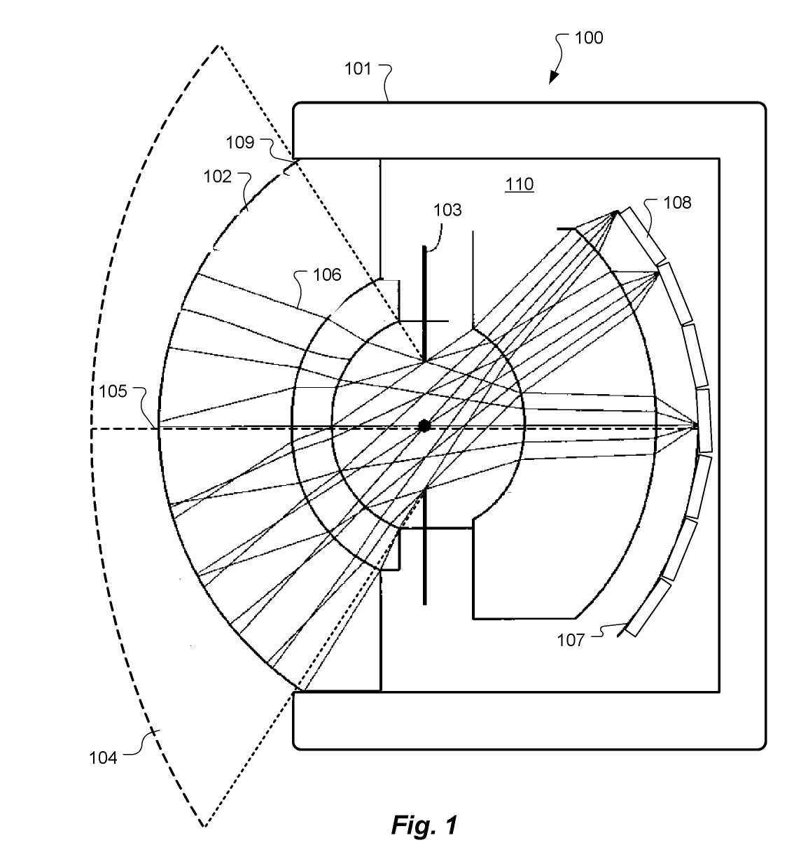

FIG. 1 shows various structural elements in an optical device 100 according to an embodiment of the present invention for a wide field of view optical system. A device housing 101 has an optical opening 109 into an enclosed interior volume 110. A multi-element lens 102 is molded across the optical opening 109 and is defined by a field of view 104 that represents a volume of space from which light is collected that is defined by the optical opening 109 and the geometry of the exposed lens across the optical opening 109 together with a lens aperture 103 at the center of lens 102 through which collected light passes. In specific embodiments, the lens 102 may be the lens may be a multi-element monocentric lens.

A boresight axis 105 is perpendicular to the field of view 104, and there are multiple optical paths 106 through the lens 102 that define one or more focal planes 107 within the interior volume 110. One or more optical sensors 108 are arranged on the focal planes 107 and configured for sensing light collected through the lens 102 from the field of view 104. In specific embodiments, the optical sensors 108 may be configured in one or more focal plane arrays (FPAs) such as one or more curved focal plane arrays, and the optical sensors 108 may include a single diamond turned optical fiber bundle, or multiple diamond turned optical fiber bundles. The optical sensors 108 may be structurally integrated into the lens 102, or they may be structurally separate from the lens 102. In any of the embodiments, there may further be one or more optical corrective elements coupled to the optical sensors 108. The device housing 101 and the lens 102 form an integrated package that is environmentally hardened to absorb impulse shocks without disturbing the boresight axis 105 or the optical paths 106.

Depending on the image fidelity needed for the image processing algorithms of the system, the lens 102 may be formed of molded plastic material or molded glass material. For example, if the specific application allows use of molded plastic material for a lens 102 that is composed of plastic optical elements, the lens optics may be incorporated into an injection mold that is used to produce the optical device 100. Use of plastic lens material rather than glass represents some sacrifice in optical quality, but the injection molding of the optical elements inherently results in a lens 102 that is naturally shock resistant and optically aligned. The specific shape and positioning of the plastic optical elements of the lens 102 will be as good as the tolerances of the mold that is used, and the optical system can be improved by revising the mold. The trade-off with use of plastic lens material will be optical quality and varying index of refraction through the material in place of positioning and alignment difficulties and errors associated with integration and environment. Reducing the number of materials used in the injection molding limits the amount of dispersions in the system.

Some image navigation systems will require higher quality glass optical elements in the lens 102. In that case, an environmentally hardened multi-element optical device 100 can still be produced, focusing on a reduction of boresight misalignments in both production and high-g/high impulse environments. Injection of glass material for the lens 102 together with a device housing 101 made of metal material can allow for similar shock resistance and alignment qualities as with a plastic injection molding device.

Although various exemplary embodiments of the invention have been disclosed, it should be apparent to those skilled in the art that various changes and modifications can be made which will achieve some of the advantages of the invention without departing from the true scope of the invention.

What is claimed is:

1. An optical device for a wide field of view optical system, the device comprising:
device housing having an optical opening into an enclosed interior volume;
a multi-element lens molded across the optical opening and defined by:
a. a field of view representing a volume of space from which light is collected,
b. a plurality of optical paths through the lens defining one or more focal planes within the interior volume, and
c. a boresight axis perpendicular to each of the one or more focal planes; and
a plurality of optical sensors arranged on the one or more focal planes and configured for sensing light collected through the lens from the field of view;
wherein the device forms a single environmentally hardened package configured to absorb impulse shocks without disturbing the boresight axis or the plurality of optical paths.

2. The optical device according to claim 1, wherein the lens is formed of molded plastic material.

3. The optical device according to claim 1, wherein the lens is formed of molded glass material.

4. The optical device according to claim 1, wherein the lens is a monocentric lens.

5. The optical device according to claim 1, wherein the plurality of optical sensors are configured in one or more focal plane arrays.

6. The optical device according to claim 5, wherein the one or more focal plane arrays form one or more curved focal plane arrays.

7. The optical device according to claim 1, wherein the plurality of optical sensors comprise a single diamond turned optical fiber bundle.

8. The optical device according to claim 1, wherein the plurality of optical sensors comprise a plurality of diamond turned optical fiber bundles.

9. The optical device according to claim 1, wherein the one or more focal planes and the plurality of optical sensors are structurally integrated into the lens.

10. The optical device according to claim 1, wherein the one or more focal planes and the plurality of optical sensors are structurally separate from the lens.

11. The optical device according to claim 1, further comprising:
one or more optical corrective elements coupled to the plurality of optical sensors.

12. A wide field of view optical system having at least one optical device according to any of claims 1-11.
